(19) United States
(12) Patent Application Publication
(10) Pub. No.: US 2026/0036935 A1
(43) Pub. Date: Feb. 5, 2026

(54) SHEET PROCESSING APPARATUS THAT BONDS PLURALITY OF SHEETS TOGETHER, AND IMAGE FORMING SYSTEM

(71) Applicant: CANON KABUSHIKI KAISHA, Tokyo (JP)

(72) Inventor: TAKAHIRO ENDO, Shizuoka (JP)

(21) Appl. No.: 19/280,569

(22) Filed: Jul. 25, 2025

(30) Foreign Application Priority Data
Jul. 30, 2024 (JP) 2024-123434

(51) Int. Cl. G03G 15/00; G03G 15/23

(52) U.S. Cl. CPC G03G 15/6544; G03G 15/234; G03G 15/6552; G03G 15/6585; G03G 2215/00556; G03G 2215/00734; G03G 2215/00738; G03G 2215/00835

(57) ABSTRACT

A sheet processing apparatus includes: a conveyance unit configured to convey a sheet to a loading board; a bonding unit configured to execute bonding processing for bonding together a plurality of loaded sheets loaded on the loading board, with use of an adhesive image formed on the plurality of loaded sheets; and a control unit configured to control the bonding processing executed by the bonding unit in order to create a bundle of sheets from a designated number of sheets designated by a job, wherein the control unit is further configured not to execute the bonding processing with respect to the plurality of loaded sheets in a case where a thickness of the plurality of loaded sheets exceeds a first threshold.

### FIELD OF TECHNOLOGY

The present disclosure relates to a sheet processing apparatus that bonds sheets together using toner, and to an image forming system that includes this sheet processing apparatus.

### DESCRIPTION OF RELATED ART

Japanese Patent Laid-Open No. 2004-209859 discloses an image forming system that bonds together sheets on which adhesive images have been formed using an adhesive by applying heat and pressure to the sheets in a state where the sheets overlap one another. In Japanese Patent Laid-Open No. 2004-209859, toner is used as an adhesive.

### SUMMARY

According to an aspect of the present disclosure, a sheet processing apparatus includes: a conveyance unit configured to convey a sheet to a loading board; a bonding unit configured to execute bonding processing for bonding together a plurality of loaded sheets loaded on the loading board, with use of an adhesive image formed on the plurality of loaded sheets; and a control unit configured to control the bonding processing executed by the bonding unit in order to create a bundle of sheets from a designated number of sheets designated by a job, wherein the control unit is further configured not to execute the bonding processing with respect to the plurality of loaded sheets in a case where a thickness of the plurality of loaded sheets exceeds a first threshold.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a schematic cross-sectional diagram of an image forming system according to some embodiments.

FIG. 2 is a schematic cross-sectional diagram of a bonding apparatus according to some embodiments.

FIG. 3A to FIG. 3C are explanatory diagrams of exemplary operations of the bonding apparatus.

FIG. 4A and FIG. 4B are diagrams showing examples of an adhesive image.

FIG. 5 is a diagram showing a schematic hardware configuration of the image forming system according to some embodiments.

FIG. 6 is a functional block diagram of a main control unit according to some embodiments.

FIG. 7 is an explanatory diagram of a restriction on a thickness of a bundle of sheets.

FIG. 8 is a flowchart of processing for creating a bundle of sheets according to an embodiment.

FIG. 9 is a flowchart of processing for creating a bundle of sheets according to an embodiment.

FIG. 10 is a flowchart of processing for creating a bundle of sheets according to an embodiment.

FIG. 11 is a flowchart of processing for creating a bundle of sheets according to an embodiment.

FIG. 12A and FIG. 12B are explanatory diagrams of the occurrence of a jam caused by curling of a bundle of sheets.

FIG. 13 is a diagram showing an exemplary relationship between a type and a size of a sheet and an adjustment value.

FIG. 14 is a flowchart of processing for creating a bundle of sheets according to an embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

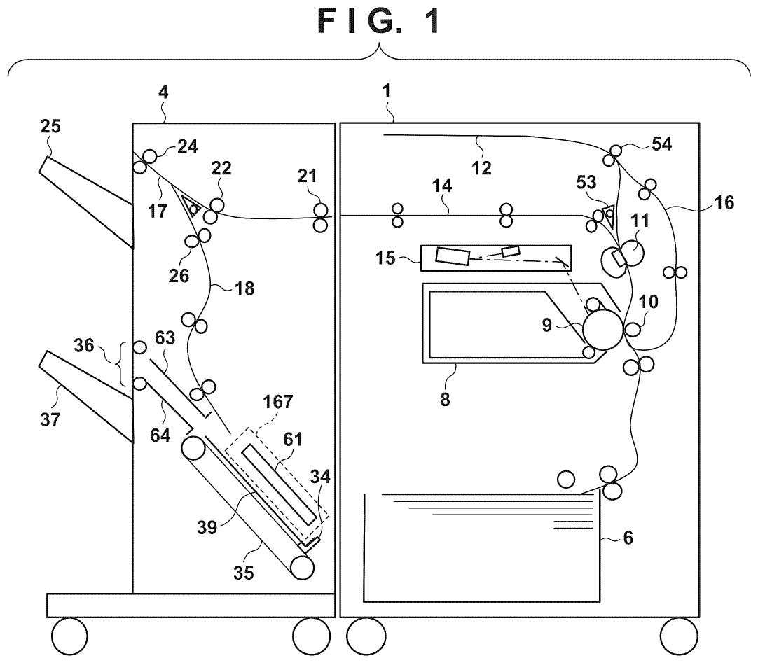

FIG. 1 is a cross-sectional diagram showing a schematic configuration of an image forming system according to the present embodiment. The image forming system includes an image forming apparatus 1 and a sheet processing apparatus 4. The image forming apparatus 1 includes an image forming cartridge 8 provided with a photosensitive member 9. An exposure apparatus 15 exposes the photosensitive member 9 that has been charged to light, thereby forming an electrostatic latent image on the photosensitive member 9. The image forming cartridge 8 develops the electrostatic latent image on the photosensitive member 9 using toner, thereby forming a toner-based image on the photosensitive member 9. A transfer roller 10 transfers the image formed on the photosensitive member 9 to a sheet conveyed from a cassette 6. A fixing unit 11 fixes the image transferred to the sheet on the sheet by applying heat and pressure to the sheet.

In a case where the image is formed only on one side of the sheet, the sheet that has passed through the fixing unit 11 is conveyed to a horizontal conveyance path 14. In a case where the image is formed on both sides of the sheet, the sheet that has passed through the fixing unit 11 is conveyed toward a reverse conveyance path 12. A flapper 53 is a directing member that directs the sheet to the horizontal conveyance path 14 or the reverse conveyance path 12. After the sheet has been conveyed toward the reverse conveyance path 12, the rotation direction of a reverse roller 54 is reversed from the previous rotation direction, and consequently, the sheet is conveyed toward a double-sided conveyance path 16. The sheet that has been conveyed toward the double-sided conveyance path 16 is conveyed to the position opposing the transfer roller 10 again, and an image is transferred to the other side of the sheet. After the fixing unit 11 has fixed the image transferred to the other side of the sheet, the sheet is conveyed to the horizontal conveyance path 14.

Note that in the present embodiment, toner is used as an adhesive in bonding processing in the sheet processing apparatus 4. In the following description, among images that are formed on the photosensitive member 9 and sheets, an image formed as an adhesive for the bonding processing in the sheet processing apparatus 4 will be referred to as an adhesive image, and other images will be referred to as user images. An adhesive image is formed inside an adhesive region that is decided in accordance with a configuration of a bonding apparatus 167 in the sheet processing apparatus 4, which will be described later.

Also, the image forming apparatus 1 of the present embodiment is, for example, a monochrome image forming apparatus that forms a monochrome image using toner of a single color, such as black, and therefore the black-colored toner is used for both of a user image and an adhesive image. However, the image forming apparatus 1 may be, for example, a color image forming apparatus that forms a color image using toners of a plurality of colors, such as yellow, cyan, magenta, and black. In this case, it is possible to adopt a configuration in which each of the toners of the plurality of colors is used in formation of a user image, and toners of one or more of the plurality of colors are used in formation of an adhesive image. Furthermore, it is also possible to adopt a configuration in which one toner among the plurality of toners is used only in formation of an adhesive image, and remaining toners are used only in formation of a user image. Toner that is used only in formation of an adhesive image may be transparent.

The sheet that has been conveyed to the horizontal conveyance path 14 is conveyed to the sheet processing apparatus 4. The sheet that has been conveyed to the sheet processing apparatus 4 is conveyed toward a reverse conveyance path 17 by conveyance rollers 21 and 22. In a case where the bonding processing for sheets is not to be executed, the sheet conveyed to the reverse conveyance path 17 is discharged to an upper tray 25 by a discharge roller 24. In a case where the bonding processing for sheets is to be executed, the sheet conveyed to the reverse conveyance path 17 is conveyed toward a processing conveyance path 18 by reverse rotation of the discharge roller 24. The sheet conveyed to the processing conveyance path 18 is conveyed to and loaded on a loading board 39.

The bonding apparatus 167, which includes a bonding unit 61, executes alignment processing and bonding processing for a plurality of sheets loaded on the loading board 39. A bundle discharge guide 34 pushes out a bundle of sheets formed by the bonding processing toward a pair of discharge rollers 36 via a gap between an upper guide 63 and a lower guide 64. Note that the bundle discharge guide 34 is driven by a guide driving unit 35. The pair of discharge rollers 36 discharges the bundle of sheets to a lower tray 37.

Note that the sheet processing apparatus 4 can be configured so that sheets are conveyed to and loaded on the loading board 39 one by one. Alternatively, the sheet processing apparatus 4 can be configured so that a plurality of sheets are stacked on the upstream side of the loading board 39 in later-described buffer processing, and then the plurality of stacked sheets are collectively conveyed to and loaded on the loading board 39. Furthermore, the sheet processing apparatus 4 can be configured to selectively set an operation mode that executes the buffer processing, and an operation mode that does not execute the buffer processing.

For example, in a case where the buffer processing is executed, conveyance of a first sheet is stopped on the processing conveyance path 18 by suspending the rotation of a conveyance roller 26. Then, in harmony with a timing at which a second sheet succeeding the first sheet is conveyed to the reverse conveyance path 17, the conveyance roller 26 conveys the first sheet, too, to the reverse conveyance path 17. In this way, the first sheet and the second sheet are stacked on the reverse conveyance path 17. The first sheet and the second sheet that have been stacked are conveyed toward the processing conveyance path 18 by the discharge roller 24. In a case where three or more sheets are to be stacked, the foregoing processing is repeated. Once a predetermined number of sheets have been stacked, these predetermined number of stacked sheets are conveyed to the loading board 39.

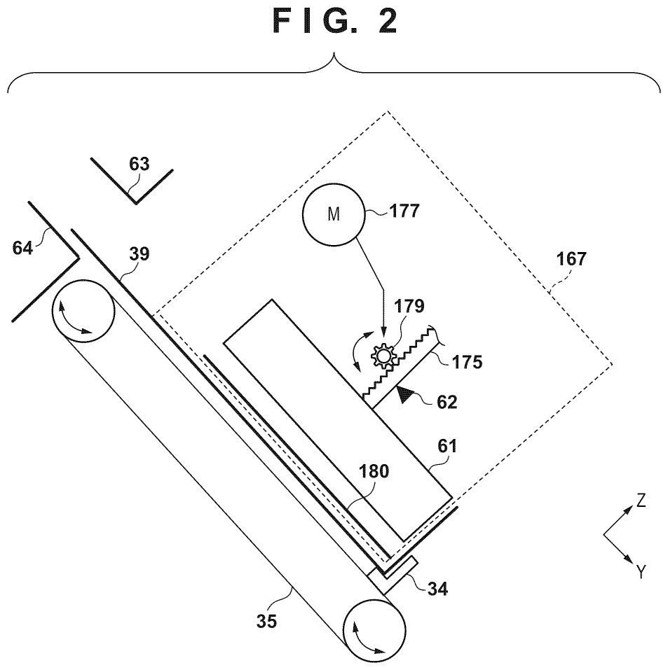

FIG. 2 is a schematic configuration diagram of the bonding apparatus 167. The bonding unit 61 is configured to be capable of moving in the direction toward the loading board 39, and in the direction away from the loading board 39. In the following description, the moving direction of the bonding unit 61 is defined as a Z direction as indicated in FIG. 2. Also, the conveyance direction of a sheet or a bundle of sheets in the vicinity of the bonding apparatus 167 is defined as a Y direction. In the present embodiment, the Z direction is a direction that is perpendicular to the Y direction. Furthermore, a direction that is perpendicular to both of the Z direction and the Y direction is defined as an X direction. The Z direction, the Y direction, and the X direction are also referenced as a height direction, a length direction, and a width direction, respectively.

A motor 177 causes a pinion gear 179 to rotate. The rotation of the pinion gear 179 causes a rack gear 175, which engages with the pinion gear 179, to move in the Z direction. The bonding unit 61 is configured to move in the Z direction in coordination with the movement of the rack gear 175. A home position (HP) sensor 62 detects whether the bonding unit 61 is at a predetermined position in the Z direction. In the following description, this predetermined position will be referred to as a “home position”. The home position is also a standby position of the bonding unit 61. A receiving plate 180 is formed of an elastic material, such as silicon rubber. The bonding unit 61 is configured to be movable in the −Z direction to a position at which it comes into contact with the receiving plate 180.

The bonding apparatus 167 executes the alignment processing and the bonding processing with respect to sheets loaded on the loading board 39. The alignment processing is processing for aligning the positions of the sheets loaded on the loading board 39 in the X direction and the Y direction. The bonding processing is processing for applying heat and pressure to an adhesive region of the sheets loaded on the loading board 39 with use of the bonding unit 61, thereby causing the sheets loaded on the loading board 39 to be bonded together by an adhesive image formed inside the adhesive region. Note that the bonding apparatus 167 executes the bonding processing once or more in order to form a bundle of a designated number of sheets designated by a print job. For example, assume that a bundle of sheets composed of P sheets is to be formed (P is an integer equal to or larger than 2). When S sheets (additional sheets) have been newly loaded on the loading board 39 (S is an integer equal to or larger than 1), or when the last sheet (additional sheet) in the bundle of sheets has been loaded on the loading board 39, the bonding apparatus 167 executes the bonding processing with respect to the sheets loaded on the loading board 39. Therefore, in a case where P≤S, a bundle of sheets is formed by executing the bonding processing once. In a case where P>S, a bundle of sheets is formed by executing the bonding processing multiple times. The number of times the bonding processing is executed is calculated as an integer that is obtained by rounding up the value of the result of dividing P by S to the nearest whole number. Note that although the value of S during formation of one bundle of sheets is assumed to be constant in the present example, it is also possible to adopt a configuration in which the value of S is changed dynamically during formation of one bundle of sheets.

In the following description, sheets loaded on the loading board 39 will be referred to as “loaded sheets”. Note that even in a case where a plurality of loaded sheets are loaded on the loading board 39, an entirety of these plurality of loaded sheets will be simply referred to as a “loaded sheet(s)”. Furthermore, in the following description, it is assumed that the “thickness of loaded sheets” means the thickness (the length in the Z direction) of an entirety of the loaded sheets loaded on the loading board 39.

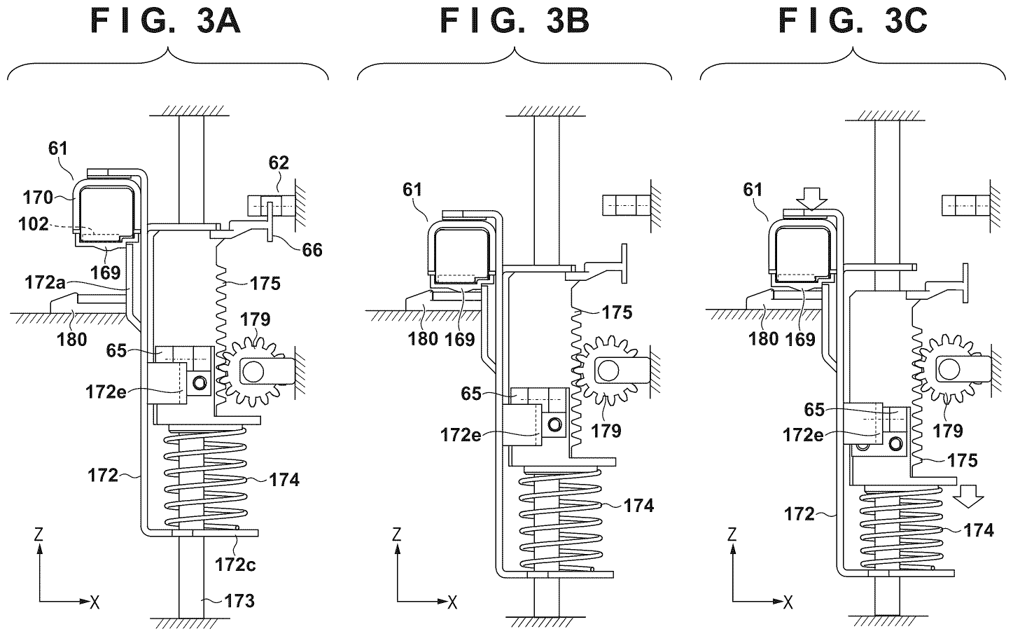

FIG. 3A to FIG. 3C are detailed cross-sectional diagrams of the bonding apparatus 167 when viewing the bonding apparatus 167 toward the Y direction in FIG. 2. Note that FIG. 3A shows a state where the bonding unit 61 is at the home position. FIG. 3B shows a state where the bonding unit 61 has been moved in the −Z direction from the state of FIG. 3A, and the bonding unit 61 has come into contact with the receiving plate 180. FIG. 3C shows a state where the rack gear 175 has been further moved in the −Z direction from the state of FIG. 3B, and the bonding unit 61 is consequently applying pressure to the receiving plate 180. Note that reference signs of a part of members are omitted in FIG. 3B and FIG. 3C to simplify the drawings.

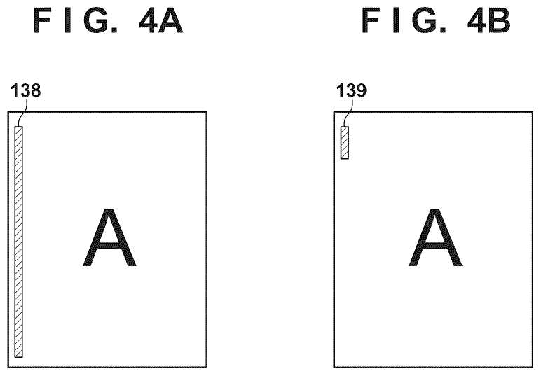

Note that although sheets are not shown in FIG. 3A to FIG. 3C, in a case where the sheets are loaded on the loading board 39, the sheets are loaded on the loading board 39 in such a manner that a part thereof covers the receiving plate 180. Also, the number of sheets that can be loaded on the loading board 39 can be restricted so that the sheets loaded on the loading board 39 do not come into contact with the bonding unit 61 at the home position. Furthermore, the bonding unit 61 applies heat and pressure to a part or an entirety of a region of the sheets that is covering the receiving plate 180. The region of the sheets to which heat and pressure are applied by the bonding unit 61 is an adhesive region, and an adhesive image is formed inside this adhesive region. For example, a bundle of sheets bound at a long edge can be created by forming an adhesive image 138 shown in FIG. 4A in the adhesive region. Also, a bundle of sheets bound at a corner can be created by forming an adhesive image 139 shown in FIG. 4B in the adhesive region.

Returning to FIG. 3A to FIG. 3C, the bonding unit 61 is provided with a pressurizing plate 169, a ceramic heater 102, a metallic stay 170, and a non-illustrated thermistor. The pressurizing plate 169 is a pressurizing member that applies pressure to loaded sheets. When viewed in the Z direction, the pressurizing plate 169 has a substantially rectangular shape with long edges in the Y direction and short edges in the X direction. The pressurizing plate 169 is made of aluminum, for example. The ceramic heater 102 is a heating unit that applies heat to the pressurizing plate 169. The non-illustrated thermistor detects the temperature of the ceramic heater 102. The pressurizing plate 169 and the ceramic heater 102 are held by the metallic stay 170. The metallic stay 170 is fixed to a lift plate 172. The lift plate 172 moves integrally with the bonding unit 61.

The rack gear 175 is configured so that it can be moved in the Z direction by a cylindrical guide shaft 173 fixed to a frame body of the bonding apparatus 167. As has been described using FIG. 2, the pinion gear 179 engages with the rack gear 175, and the rotation of the pinion gear 179 causes the rack gear 175 to move in the Z direction.

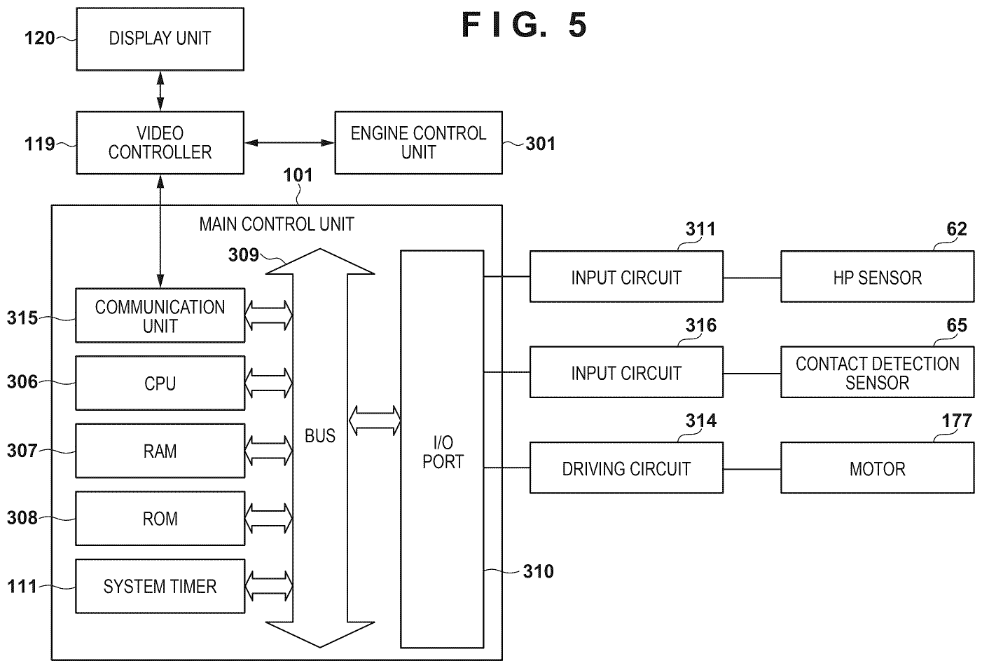

The HP sensor 62 is, for example, a photointerrupter fixed to the frame body of the bonding apparatus 167. In a case where the bonding unit 61 is at the home position, a flag 66, which has been molded integrally with the rack gear 175, shields light from a light emitting element to a light receiving element of the photointerrupter. Also, in a case where the bonding unit 61 is not at the home position, the flag 66 allows transmission of light from the light emitting element to the light receiving element of the photointerrupter. The HP sensor 62 notifies a main control unit 101 (FIG. 5) in the image forming system of the result of light detection by this light receiving element. Therefore, the main control unit 101 can detect whether the bonding unit 61 is at the home position based on the result of light detection notified by the HP sensor 62. Note that the flag 66 may be configured to allow transmission of light from the light emitting element to the light receiving element of the photointerrupter in a case where the bonding unit 61 is at the home position, and shield the light in a case where the bonding unit 61 is at other positions.

A contact detection sensor 65 is, for example, a photointerrupter, and is held integrally with the rack gear 175. The contact detection sensor 65 notifies the main control unit 101 (FIG. 5) of whether it has detected a rib plate 172e of the lift plate 172. A compression spring 174 for causing the pressurizing plate 169 to generate a pressurizing force in the −Z direction is arranged between the rack gear 175 and a lower surface 172c of the lift plate 172. Furthermore, the lift plate 172 includes a width alignment member 172a for regulating the position of sheets loaded on the loading board 39 in the X direction, thereby aligning the position of the sheets loaded on the loading board 39 in the X direction.

As shown in FIG. 3A and FIG. 3B, during a time period in which the bonding unit 61 comes into contact with the receiving plate 180 (or an upper side of the loaded sheets) from the home position, the contact detection sensor 65 detects the rib plate 172e of the lift plate 172. That is to say, the rib plate 172e shields an optical path from the light emitting element to the light receiving element of the contact detection sensor 65. Even if the pinion gear 179 is further rotated from the state of FIG. 3B, as the receiving plate 180 regulates the movements of the bonding unit 61 and the lift plate 172 in the −Z direction, only the rack gear 175 pushes down the compression spring 174 and moves in the −Z direction. As only the rack gear 175 moves in the −Z direction, relative positions of the contact detection sensor 65 and the rib plate 172e change, and the rib plate 172e no longer shields the optical path from the light emitting element to the light receiving element of the contact detection sensor 65.

As the contact detection sensor 65 no longer detects the rib plate 172e, the main control unit 101 (FIG. 5) detects the change in the relative positions of the rack gear 175 and the lift plate 172. This change in the relative positions occurs as a result of the bonding unit 61 coming into contact with the upper side of the loaded sheets, and a timing at which the contact detection sensor 65 has detected the change in the relative positions will be hereinafter referred to as a “sheet contact timing”. When the rack gear 175 has moved by a predetermined distance in the-Z direction since the sheet contact timing, the main control unit 101 (FIG. 5) stops the rotation of the pinion gear 179 (the state of FIG. 3C). In this state, the compression spring 174 causes the pressurizing plate 169 to generate a pressurizing force toward the receiving plate 180 in the −Z direction via the lift plate 172.

FIG. 5 is a block diagram showing a hardware configuration of the image forming system. Note that in FIG. 5, members that are not necessary for the description of the present embodiment are omitted. A video controller 119 controls an engine control unit 301 that controls the image forming apparatus 1, and the main control unit 101 that controls the sheet processing apparatus 4. Also, the video controller 119 controls a display unit 120. The display unit 120 provides an input interface and an output interface to a user of the image forming system.

The main control unit 101 includes a CPU 306 that is a processor, a RAM 307 that is a volatile memory, a ROM 308 that is a non-volatile memory, a system timer 111, a communication unit 315, and an I/O port 310, which are connected to one another via a bus 309. The communication unit 315 executes processing for communication with the video controller 119. The CPU 306 controls an entirety of the sheet processing apparatus 4 by executing a program stored in the ROM 308. At this time, the CPU 306 stores, for example, control data necessary for control on the sheet processing apparatus 4 into the RAM 307. The ROM 308 stores the program executed by the CPU 306, and control data used in control on the sheet processing apparatus 4. The system timer 111 generates timings necessary for various types of control.

The I/O port 310 obtains a result of detection by the HP sensor 62 via an input circuit 311, and notifies the CPU 306 of the same. Furthermore, the I/O port 310 obtains a result of detection by the contact detection sensor 65 via an input circuit 316, and notifies the CPU 306 of the same. Also, the CPU 306 controls the rotation of the motor 177 by controlling a driving circuit 314 via the I/O port 310. The motor 177 is a driving source for the pinion gear 179.

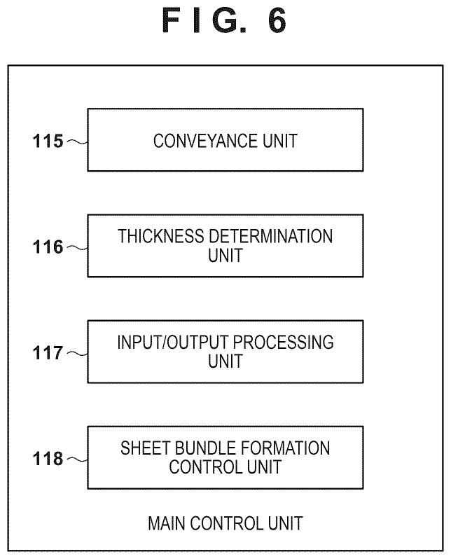

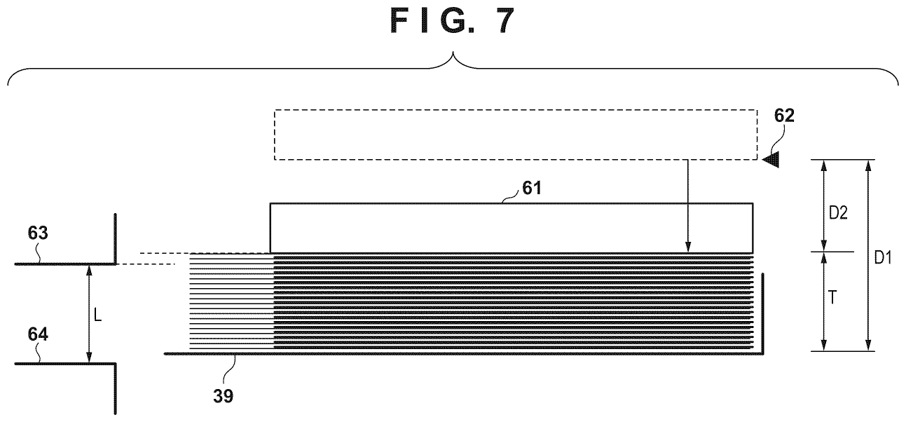

FIG. 6 shows functional blocks that are realized by the main control unit 101 as a result of the main control unit 101 executing the program. Note that in FIG. 6, only functional blocks that are necessary for the description of the present embodiment are shown. A conveyance unit 115 controls conveyance of sheets, discharge of a bundle of sheets, and the like in the sheet processing apparatus 4. A thickness determination unit 116 determines the thickness of loaded sheets. For example, assume that the distance moved by which the bonding unit 61 from the home position to a point where the bonding unit 61 comes into contact with the receiving plate 180 is DI as shown in FIG. 7. D1 is a known value. The thickness determination unit 116 determines a distance D2 moved by the bonding unit 61 from the home position (a first position) to the position of the bonding unit 61 at the aforementioned sheet contact timing (a second position). In this way, the thickness determination unit 116 can calculate a thickness T of the loaded sheets as D1-D2. Note that D2 can be determined by the amount of rotation of the pinion gear 179, hence the amount of rotation of the motor 177.

A sheet bundle formation control unit 118 executes processing for forming a bundle of sheets. Specifically, the sheet bundle formation control unit 118 performs control on the temperature of the ceramic heater 102 in the bonding unit 61, control on the movement of the bonding unit 61 in the Z direction, and the like. An input/output processing unit 117 displays a status of progress of a print job, executes processing for notifying the user of the image forming system of, for example, an alarming, and the like.

For example, assume that the distance between the upper guide 63 and the lower guide 64 is L as shown in FIG. 7. In this case, if the thickness T of the loaded sheets becomes larger than L, then a jam can occur when a bundle of sheets is discharged. It is possible to adopt a configuration in which an upper limit is provided for the number of sheets included in the bundle of sheets, so as to prevent a jam of the bundle of sheets. This upper limit for the number of sheets can be set based on, for example, the maximum value of the thickness of sheets that can be used in the image forming system. In a case where the bundle of sheets is formed using sheets having a small thickness, this upper limit for the number of sheets is fewer than the number of sheets that can be included in the bundle of sheets to the extent that a jam is not caused in practice. For this reason, in the present embodiment, the upper limit for the number of sheets is not set in advance. Instead, the thickness determination unit 116 determines the thickness T of the loaded sheets at the time of the bonding processing. Then, if the thickness T of the loaded sheets exceeds a first threshold, the sheet bundle formation control unit 118 aborts the processing for forming the bundle of sheets to suppress the occurrence of a jam when the bundle of sheets is discharged. Note that the first threshold can be, for example, a distance L between the upper guide 63 and the lower guide 64. Alternatively, the first threshold can be a value obtained by subtracting a predetermined margin from the distance L between the upper guide 63 and the lower guide 64. The first threshold is decided and stored into the ROM 308 in advance.

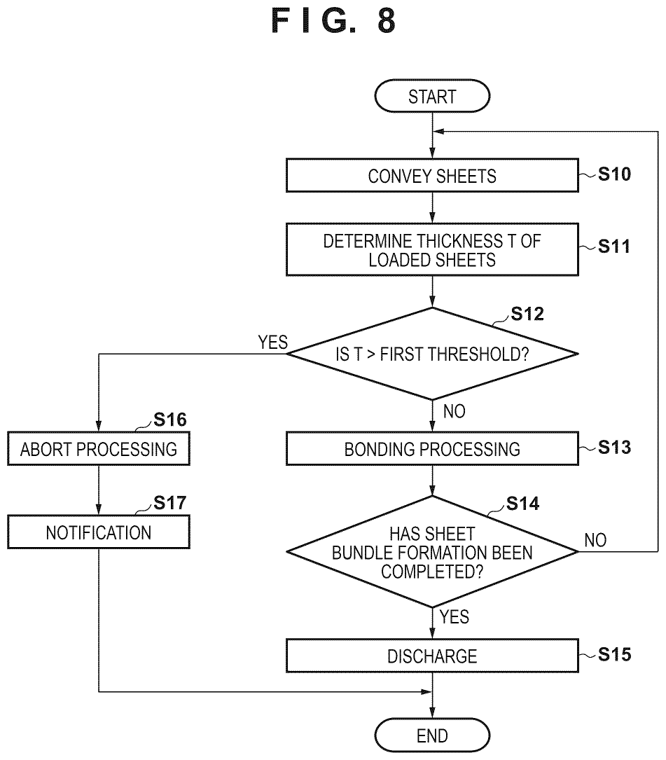

FIG. 8 is a flowchart of processing that is executed by the main control unit 101 in the present embodiment to form one bundle of sheets. In step S10, the conveyance unit 115 conveys sheets to the loading board 39. Once a predetermined number of sheets or the last sheet in the bundle of sheets has been conveyed to the loading board 39, the sheet bundle formation control unit 118 causes the bonding unit 61 to move from the home position toward the sheets. In step S11, the thickness determination unit 116 determines a thickness T of the loaded sheets based on the distance D2 moved by the bonding unit 61. In step S12, the sheet bundle formation control unit 118 compares the thickness T of the loaded sheets with the first threshold. In a case where the thickness T of the loaded sheets is equal to or smaller than the first threshold, the sheet bundle formation control unit 118 executes bonding processing in step S13. In step S14, the sheet bundle formation control unit 118 determines whether formation of one bundle of sheets has been completed. In a case where formation of one bundle of sheets has not been completed, the sheet bundle formation control unit 118 repeats processing from step S10. In a case where formation of one bundle of sheets has been completed, the conveyance unit 115 executes processing for discharging the bundle of sheets to the outside of the image forming system in step S15, and ends processing of FIG. 8.

On the other hand, in a case where the thickness T of the loaded sheets is larger than the first threshold in step S12, the sheet bundle formation control unit 118 aborts the processing for forming the bundle of sheets in step S16. As the formation processing has been aborted, the conveyance unit 115 stops conveyance to the loading board 39 with respect to sheets that have already been conveyed to the image forming system but have not been conveyed to the loading board 39. For example, the conveyance unit 115 discharges, to the upper tray 25, sheets that have not been conveyed to the loading board 39 when the processing for forming the bundle of sheets aborted. Furthermore, the sheet bundle formation control unit 118 also causes the video controller 119 to stop image formation of a succeeding sheet(s) in the image forming apparatus 1. Then, the sheet bundle formation control unit 118 causes the input/output processing unit 117 to notify the abortion of the processing for forming the bundle of sheets, and a procedure for taking out the loaded sheets, in step S17. A notification destination can be, for example, the display unit 120, or a personal computer (PC) connected to the image forming system via the network.

Note that in a case where the first threshold is the distance L between the upper guide 63 and the lower guide 64, the thickness T of the loaded sheets exceeds L in step S12, and thus the loaded sheets cannot be pushed out toward the pair of discharge rollers 36. However, in a case where the first threshold is a value smaller than the distance L between the upper guide 63 and the lower guide 64, the thickness T of the loaded sheets can be prevented from exceeding L in step S12. In this case, the conveyance unit 115 can be configured to discharge the loaded sheets to the lower tray 37.

As described above, according to the present embodiment, the thickness of loaded sheets is actually measured, and in a case where the thickness of the loaded sheets that has been actually measured exceeds the first threshold, the processing for forming a bundle of sheets is aborted. Therefore, a jam that occurs due to the thickness of the bundle of sheets can be suppressed without setting an upper limit for the number of sheets in the bundle of sheets in advance. The first threshold is decided in advance based on the configuration of the image forming system. In the present example, the first threshold is assumed to be the length L in the thickness direction of a discharge channel via which a bundle of sheets on the loading board 39 is discharged, or a value that is smaller than the length L by a margin.

Note that the present embodiment is not limited to suppressing a jam that occurs due to the thickness of a bundle of sheets. For example, the first threshold can be a value based on the thickness of loaded sheets that can be loaded on the loading board 39, or a value based on the thickness of loaded sheets for which the bonding processing can be executed appropriately. Setting such a first threshold makes it possible to suppress a failure to appropriately execute processing for the loaded sheets, such as the bonding processing.

### Second Embodiment

Next, a second embodiment will be described with a focus on differences from the first embodiment. In the present embodiment, the thickness determination unit 116 also determines a thickness TS of one sheet based on a thickness T of loaded sheets. As one example, assume that the thickness of loaded sheets measured during first bonding processing is T1, the thickness of loaded sheets measured during second bonding processing that is next to the first bonding processing is T2, and the number of additional sheets that have been newly conveyed to the loading board 39 for the second bonding processing after the end of the first bonding processing is X1. In this case, the thickness determination unit 116 can calculate the thickness TS of one sheet as (T2−T1)/X1 after the second bonding processing has been executed. Note, it is assumed that T1=0 in the bonding processing that is executed first to form a bundle of sheets.

Based on the thickness TS of one sheet, the thickness determination unit 116 can further estimate a thickness T3 of loaded sheets in third bonding processing that is executed next to the second bonding processing. Specifically, provided that the number of additional sheets that are newly conveyed to the loading board 39 for the third bonding processing after the end of the second bonding processing is X2, the thickness determination unit 116 can calculate the thickness T3 of loaded sheets in the third bonding processing as T2+TS×X2. Here, TS×X2 corresponds to the thickness of an entirety of one or more additional sheets. In the present embodiment, the sheet bundle formation control unit 118 aborts processing for forming a bundle of sheets in a case where the thickness T of loaded sheets in the next bonding processing determined by the thickness determination unit 116 exceeds the first threshold.

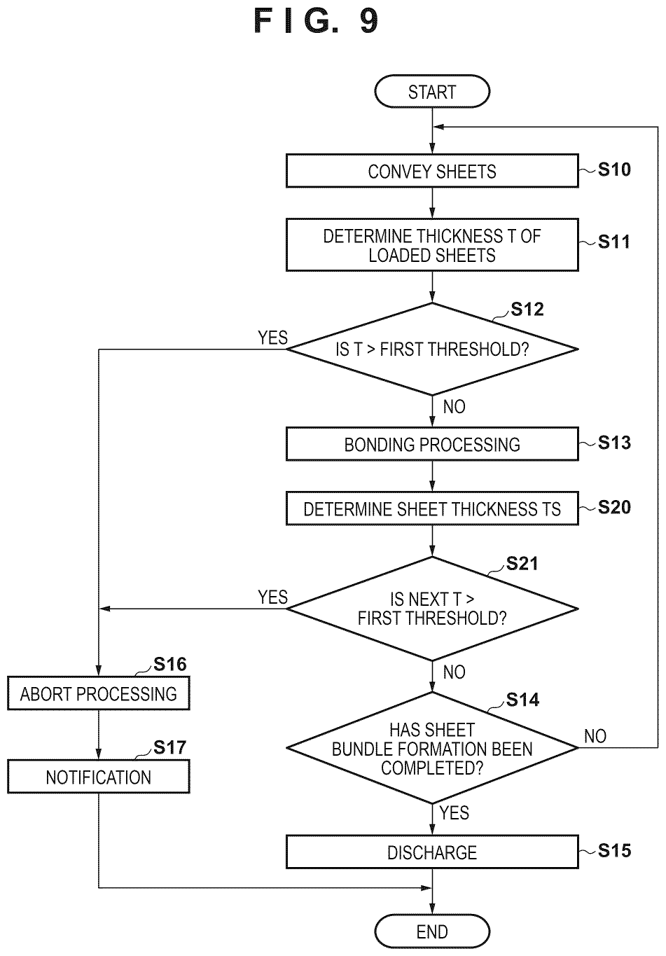

FIG. 9 is a flowchart of processing that is executed by the main control unit 101 in the present embodiment to form one bundle of sheets. Note that processing steps that are similar to those in the flowchart of the first embodiment shown in FIG. 8 are given the same step numbers thereas, and a description thereof is basically omitted. In the present embodiment, after the bonding processing has been completed in step S13, the thickness determination unit 116 determines the thickness TS of one sheet and calculates the thickness T of loaded sheets in the next bonding processing as described above in step S20. In step S21, the sheet bundle formation control unit 118 compares the thickness T of the loaded sheets in the next bonding processing with the first threshold. In a case where the thickness T of the loaded sheets in the next bonding processing is larger than the first threshold, the sheet bundle formation control unit 118 ends the processing for forming the bundle of sheets in step S16; otherwise, processing proceeds to step S14. Note that similarly to the first embodiment, in a case where the processing for forming the bundle of sheets is ended in step S16, sheets that have not been conveyed to the loading board 39 yet are discharged to, for example, the upper tray 25, rather than the loading board 39.

As described above, in the present embodiment, during the bonding processing, the thickness T of loaded sheets in the next bonding processing is determined, and in a case where the thickness T of the loaded sheets in the next bonding processing exceeds the first threshold, processing for forming a bundle of sheets is aborted. At this point, the thickness T of the loaded sheets is equal to or smaller than the first threshold; therefore, the conveyance unit 115 can discharge the loaded sheets to the lower tray 37, and a user is no longer required to remove the loaded sheets.

### Third Embodiment

Next, a third embodiment will be described with a focus on differences from the second embodiment. There are cases where a user designates a sheet type in a print job. One of the reasons that the thickness T of loaded sheets exceeds the first threshold is inconsistency between sheets that have been expected to be used by the user and a type of sheets stored in the cassette 6. In view of this, in the present embodiment, the sheet bundle formation control unit 118 sets an acceptable range of the thickness TS of one sheet based on a sheet type designated by the user in a print job. The acceptable range of the thickness TS of a sheet is a predetermined range including a nominal value of the thickness of a sheet of a sheet type designated by the user. Then, in a case where the thickness TS of one sheet determined by the thickness determination unit 116 is outside the acceptable range, the sheet bundle formation control unit 118 warns the user.

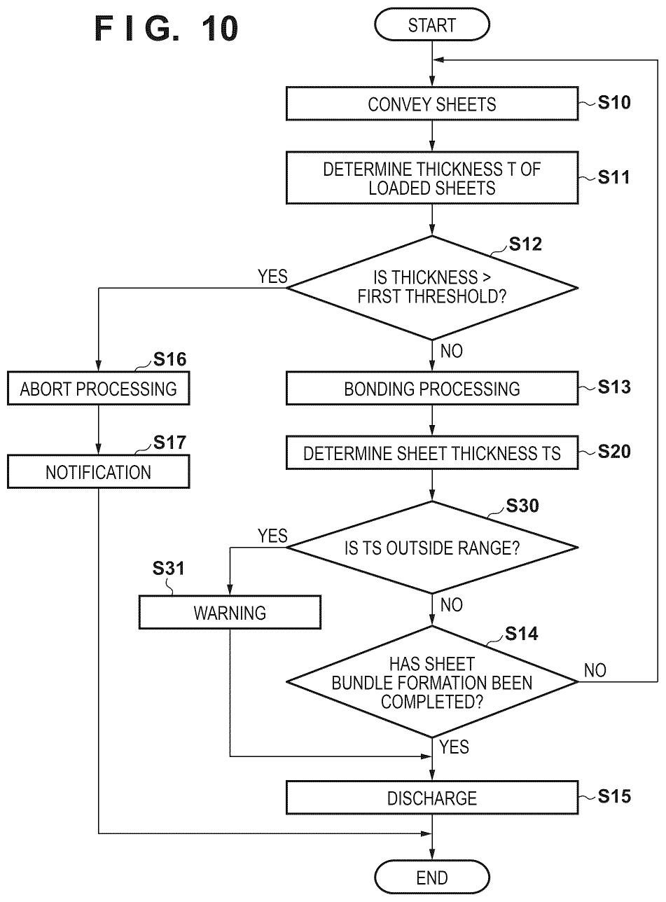

FIG. 10 is a flowchart of processing that is executed by the main control unit 101 in the present embodiment to form one bundle of sheets. Note that processing steps that are similar to those in the flowchart of the second embodiment shown in FIG. 9 are given the same step numbers thereas, and a description thereof is basically omitted. When the thickness determination unit 116 has determined the thickness TS of one sheet in step S20, the sheet bundle formation control unit 118 determines whether the thickness TS of the sheet is within the acceptable range in step S30. In a case where the thickness TS of the sheet is within the acceptable range, the sheet bundle formation control unit 118 causes processing to proceed to step S14. On the other hand, in a case where the thickness TS of the sheet is outside the acceptable range, the sheet bundle formation control unit 118 causes the input/output processing unit 117 to notify a warning in step S31. This warning can be a notification to the user that there is a possibility that the cassette 6 stores sheets of a type different from a sheet type designated in a print job. Thereafter, the sheet bundle formation control unit 118 discharges loaded sheets in step S15, and ends processing of FIG. 10.

As described above, in the present embodiment, it is possible to determine that sheets of a type different from a sheet type designated by the user in a print job have been used in formation of a bundle of sheets, and provide an early warning to the user. In this way, usability can be improved without executing unnecessary processing. Note that in the present embodiment, in a case where the thickness TS of a sheet is outside the acceptable range, loaded sheets are discharged in step S15 after a warning is provided in step S31. However, it is also possible to adopt a configuration in which, in step S15, the user is caused to perform an input indicating whether to continue formation of a bundle of sheets, the formation of the bundle of sheets is continued in a case where the user has selected the continuation, and the formation of the bundle of sheets is aborted only in a case where the user has selected the abortion. The user can change the type of sheets stored in the cassette 6 before performing an input indicating the continuation of the formation of the bundle of sheets in response to the warning. Furthermore, the present embodiment can also be combined with the second embodiment.

### Fourth Embodiment

Next, a fourth embodiment will be described with a focus on differences from the second embodiment. As described above, the number of sheets to be included in a bundle of sheets (a designated number of sheets) is designated in a print job. Therefore, the thickness determination unit 116 can determine a thickness TF of the bundle of sheets to be ultimately formed by determining the thickness TS of one sheet. For example, in a case where the thickness of current loaded sheets is T1 and the difference between the designated number of sheets and the number of current loaded sheets is X3, the thickness TF of the bundle of sheets can be calculated as T1+X3×TS. In the present embodiment, when the sheet bundle formation control unit 118 has determined that the thickness TF of the bundle of sheets exceeds the first threshold, it halts processing for forming the bundle of sheets, and notifies a message that prompts a user to change settings, or inquires whether to abort the processing for forming the bundle of sheets.

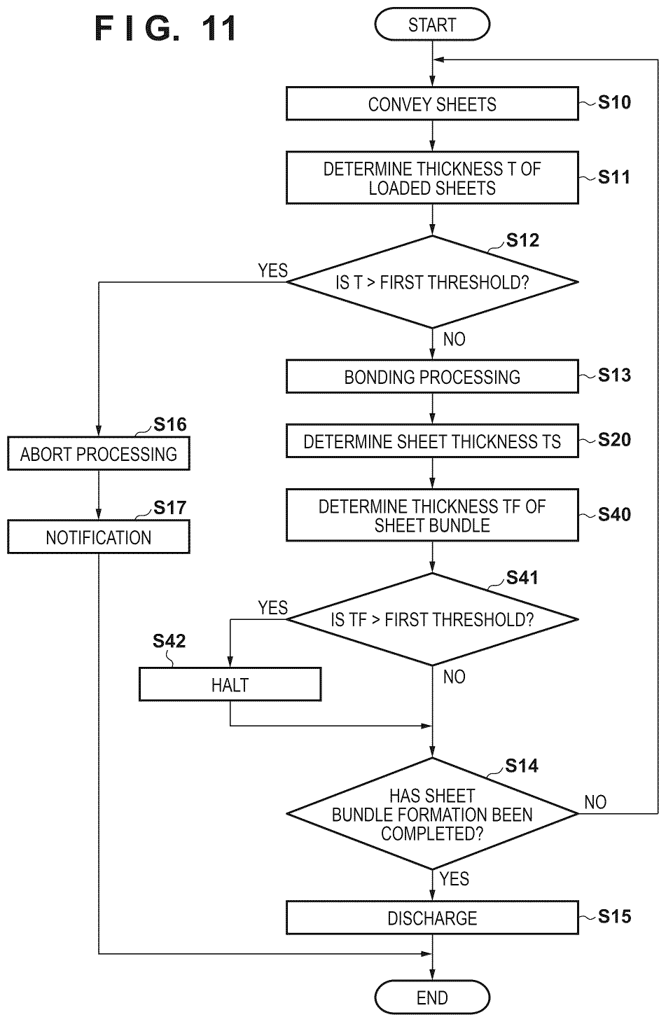

FIG. 11 is a flowchart of processing that is executed by the main control unit 101 in the present embodiment to form one bundle of sheets. Note that processing steps that are similar to those in the flowchart of the second embodiment shown in FIG. 9 are given the same step numbers thereas, and a description thereof is basically omitted. In step S40, the thickness determination unit 116 determines the thickness TF of the bundle of sheets based on the thickness TS of one sheet determined in step S20. In step S41, the sheet bundle formation control unit 118 compares the thickness TF of the bundle of sheets with the first threshold. In a case where the thickness TF of the bundle of sheets is equal to or smaller than the first threshold, the sheet bundle formation control unit 118 causes processing to proceed to step S14. On the other hand, in a case where the thickness TF of the bundle of sheets is larger than the first threshold, the sheet bundle formation control unit 118 halts the processing for forming the bundle of sheets in step S42.

Then, the sheet bundle formation control unit 118 controls the input/output processing unit 117 to notify the user that the thickness TF of the bundle of sheets exceeds a restriction, and also to prompt the user to change the number of sheets to be included in the bundle of sheets to a smaller value. Note that the sheet bundle formation control unit 118 can also present, to the user, the number of sheets that can be included in the bundle of sheets, or an upper limit value for the remaining number of sheets that can be loaded on the current loaded sheets, based on the thickness T of the current loaded sheets and the thickness TS of one sheet.

For example, when the user has input a changed value indicating a reduced number of sheets to be included in the bundle of sheets, the sheet bundle formation control unit 118 repeats processing from step S10 so as to form a bundle of sheets that are equal in number to this value. For example, in the case of a document that has been segmentalized on a per-chapter basis, a bundle of sheets that each end at a chapter break can be formed by inputting the number of sheets corresponding to the positions of chapter breaks as a changed number of sheets in the bundle of sheets. In this way, a sheet processing apparatus with great usability can be provided.

Furthermore, the sheet bundle formation control unit 118 can also prompt the user to change to thinner sheets by controlling the input/output processing unit 117. Note that at this time, the sheet bundle formation control unit 118 can also present a usable sheet type to the user by determining an acceptable thickness of one sheet based on the difference between the thickness T of current loaded sheets and the first threshold, and on the remaining number of sheets to be loaded on the current loaded sheets to form a bundle of sheets. If the user has changed the sheets in the cassette 6 and input a change in a sheet type, the sheet bundle formation control unit 118 repeats processing from step S10. As it is possible to determine that the thickness TF of a bundle of sheets exceeds the first threshold at an early stage after a print job is started, the user can complete the processing for forming the bundle of sheets by changing sheets to thinner sheets.

In addition, the sheet bundle formation control unit 118 can control the input/output processing unit 117 to present, to the user, halting of the processing for forming the bundle of sheets as an option. In a case where the user has selected halting of the processing for forming the bundle of sheets, the sheet bundle formation control unit 118 assumes that step S14 results in Yes, and causes processing to proceed to step S15. Note that the present embodiment can also be combined with the second embodiment, the third embodiment, or both of them.

### Fifth Embodiment

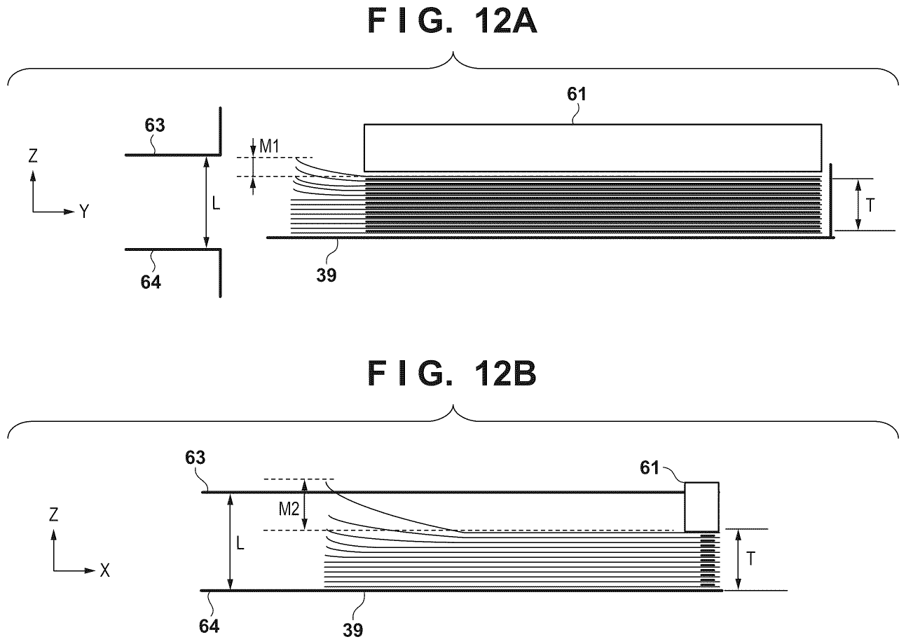

Next, a fifth embodiment will be described with a focus on differences from the first embodiment. FIG. 12A shows a state where the length of loaded sheets in the Y direction is longer than the bonding unit 61, and thus a sheet portion to which pressure and heat are not applied by the bonding unit 61 has curled. Although the thickness T of the loaded sheets in FIG. 12A is equal to or smaller than L, the thickness T+M1, which has taken the curl into account, exceeds L. Hereinafter, the curl that occurs in an end portion of the loaded sheets in the Y direction (length direction) near the upper guide 63 and the lower guide 64 will be referred to as a “length-direction curl”. FIG. 12B shows a state where an end portion of the sheets on the side opposite to the side pressed by the bonding unit 61 in the X direction (width direction) has curled. In FIG. 12B as well, although the thickness T of the loaded sheets is equal to or smaller than L, the thickness T+M2, which has taken the curl into account, exceeds L. Hereinafter, the curl that occurs in an end portion of the loaded sheets on the side opposite to the adhesive region in the X direction (width direction) will be referred to as a “width-direction curl”.

When taking into account the possibility that an end portion of the sheets can curl as shown in FIG. 12A and FIG. 12B, even if the thickness T of the loaded sheets is equal to or smaller than the first threshold, a jam can occur when a bundle of sheets is discharged, depending on the magnitude of the curl. The magnitude of the curl can vary depending on the size and the type of sheets. Therefore, in the present embodiment, the sheet bundle formation control unit 118 sets a second threshold based on the size of sheets, the type of sheets, or both of them.

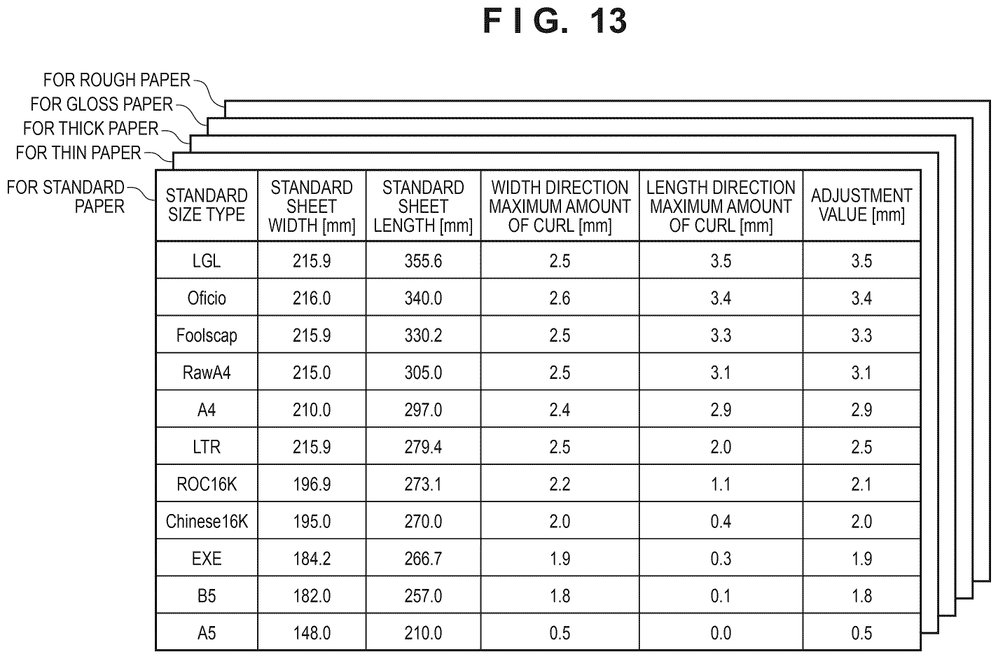

As one example, as shown in FIG. 13, the maximum value of the magnitude of the width-direction curl and the maximum value of the magnitude of the length-direction curl are determined in advance with regard to combinations of the type and the size of sheets. Then, as shown in FIG. 13, a larger one of the maximum value of the magnitude of the width-direction curl and the maximum value of the magnitude of the length-direction curl is set as an adjustment value. Adjustment value information indicating the relationship between the combinations of the type and the size of sheets and the adjustment values is stored in the ROM 308 of the main control unit 101. The sheet bundle formation control unit 118 determines an adjustment value based on the type and the size of sheets to be included in a bundle of sheets, and sets a value obtained by reducing the first threshold by the adjustment value as the second threshold. Note that the type and the size of sheets to be included in a bundle of sheets are designated in a print job. For example, according to FIG. 13, in a case where the sheets are standard paper and have an A4 size, the adjustment value is 2.9 [mm]. Therefore, the sheet bundle formation control unit 118 sets a value obtained by reducing the first threshold by 2.9 as the second threshold.

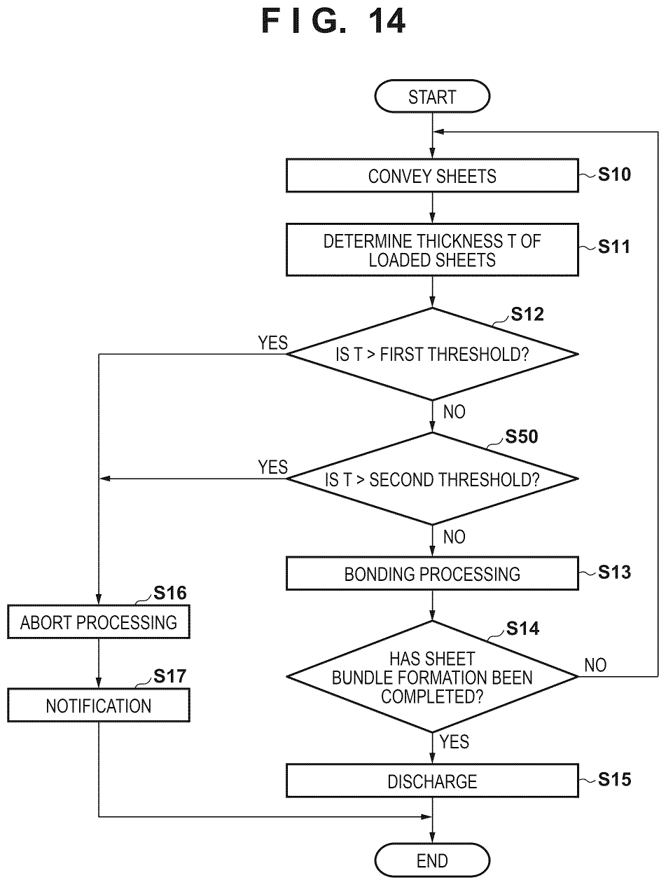

FIG. 14 is a flowchart of processing that is executed by the main control unit 101 in the present embodiment to form one bundle of sheets. Note that processing steps that are similar to those in the flowchart of the first embodiment shown in FIG. 8 are given the same step numbers thereas, and a description thereof is basically omitted. In the present embodiment, in a case where the thickness T of loaded sheets is larger than the first threshold in step S12, whether the thickness T of the loaded sheets is larger than the second threshold is determined in step S50. In a case where the thickness T of the loaded sheets is larger than the second threshold, the sheet bundle formation control unit 118 causes processing to proceed to step S16; in a case where the thickness T of the loaded sheets is equal to or smaller than the second threshold, the sheet bundle formation control unit 118 causes processing to proceed to step S13.

Note that it is also possible to adopt a configuration in which, in a case where the thickness T of the loaded sheets is larger than the second threshold in step S50, a warning is issued to a user, rather than aborting the processing for forming the bundle of sheets, in step S16. For example, it is also possible to adopt a configuration that requests the user to confirm whether a curl has occurred, and prompts the user to perform an input indicating whether to abort the processing for forming the bundle of sheets. For example, the user can perform an input indicating the continuation of the processing for forming the bundle of sheets if he/she has confirmed that the curl has not occurred, and can perform an input indicating the abortion of the processing for forming the bundle of sheets if he/she has confirmed that the curl has occurred.

Furthermore, although the first threshold in the first embodiment to the fourth embodiment is a predetermined value, it is also possible to adopt a configuration in which the first threshold in the first embodiment to the fourth embodiment is replaced with the second threshold in the present embodiment. That is to say, a configuration of the image forming system, such as a reference value based on, for example, the distance L between the upper guide 63 and the lower guide 64, can be decided in advance, and a value obtained by reducing this reference value by the adjustment value can be set as the first threshold in the first embodiment to the fourth embodiment. That is to say, it is possible to adopt a configuration in which the first threshold in the first embodiment to the fourth embodiment is dynamically set based on the type and the size of sheets designated in a print job.

Furthermore, although the adjustment value is decided based on both of the type and the size of sheets in the present example, it is also possible to adopt a configuration in which the adjustment value is decided based only on the type of sheets, or a configuration in which the adjustment value is decided based only on the size of sheets. In addition, the magnitude of the curl can vary also depending on the thickness of sheets, the density of an image formed on sheets, and whether the image is formed on one side only or on both sides. Therefore, it is possible to adopt a configuration in which the adjustment value is decided based on a combination of one or more parameters selected from among the type of sheets, the size of sheets, the thickness of sheets, the density of an image formed on a plurality of sheets to be included in a bundle of sheets, and whether the image is formed on both sides. Note that the video controller 119 determines the density of the image and whether the image is formed on both sides based on a print job, and notifies the main control unit 101 of the same.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-123434, filed Jul. 30, 2024, which is hereby incorporated by reference herein in its entirety.

What is claimed is:

1. A sheet processing apparatus, comprising:
a conveyance unit configured to convey a sheet to a loading board;
a bonding unit configured to execute bonding processing for bonding together a plurality of loaded sheets loaded on the loading board, with use of an adhesive image formed on the plurality of loaded sheets; and
a control unit configured to control the bonding processing executed by the bonding unit in order to create a bundle of sheets from a designated number of sheets designated by a job,
wherein the control unit is further configured not to execute the bonding processing with respect to the plurality of loaded sheets in a case where a thickness of the plurality of loaded sheets exceeds a first threshold.

2. The sheet processing apparatus according to claim 1, wherein
the control unit is further configured to, when the bonding processing is executed, cause the bonding unit to move from a predetermined first position at which the bonding unit is not in contact with the plurality of loaded sheets to a second position at which the bonding unit comes into contact with the plurality of loaded sheets, and determine the thickness of the plurality of loaded sheets based on a distance from the first position to the second position.

3. The sheet processing apparatus according to claim 1, wherein
in a case where the control unit executes the bonding processing multiple times to create the bundle of sheets, a combination of a plurality of first loaded sheets in first bonding processing, and one or more additional sheets loaded thereon after the first bonding processing has ended, is a plurality of second loaded sheets in second bonding processing that is next to the first bonding processing, and
the control unit is further configured to, after completion of the first bonding processing, determine a thickness of the plurality of second loaded sheets before the one or more additional sheets are loaded on the plurality of first loaded sheets, and not to execute the second bonding processing in a case where the thickness of the plurality of second loaded sheets exceeds the first threshold.

4. The sheet processing apparatus according to claim 3, wherein
the control unit is further configured to determine the thickness of the plurality of second loaded sheets by determining a thickness of an entirety of the one or more additional sheets based on the thickness of the plurality of loaded sheets in the bonding processing that has already been executed to create the bundle of sheets.

5. The sheet processing apparatus according to claim 3, wherein
the control unit is further configured to, in a case where the thickness of the plurality of second loaded sheets exceeds the first threshold, control conveyance of the one or more additional sheets so that the one or more additional sheets are not loaded on the plurality of first loaded sheets.

6. The sheet processing apparatus according to claim 1, wherein
in a case where the control unit executes the bonding processing multiple times to create the bundle of sheets, a combination of a plurality of first loaded sheets in first bonding processing, and one or more additional sheets loaded thereon after the first bonding processing has ended, is a plurality of second loaded sheets in second bonding processing that is next to the first bonding processing, and
the control unit is further configured to, after completion of the first bonding processing, determine a thickness of one sheet based on the thickness of the plurality of loaded sheets in the bonding processing that has already been executed to create the bundle of sheets, and notify a user of a warning in a case where the thickness of the one sheet is not within a range that is decided based on a sheet type designated by the job.

7. The sheet processing apparatus according to claim 6, wherein
the control unit is further configured not to execute the second bonding processing in a case where the thickness of the one sheet is not within the range.

8. The sheet processing apparatus according to claim 1, wherein
in a case where the control unit executes the bonding processing multiple times to create the bundle of sheets, a combination of a plurality of first loaded sheets in first bonding processing, and one or more additional sheets loaded thereon after the first bonding processing has ended, is a plurality of second loaded sheets in second bonding processing that is next to the first bonding processing, and
the control unit is further configured to determine a thickness of the bundle of sheets after completion of the first bonding processing, and execute processing for notifying a user of a message before the second bonding processing is started in a case where the thickness of the bundle of sheets exceeds the first threshold.

9. The sheet processing apparatus according to claim 8, wherein
the control unit is further configured to determine a thickness of one sheet based on the thickness of the plurality of loaded sheets in the bonding processing that has already been executed to create the bundle of sheets, and determine the thickness of the bundle of sheets based on a difference between the number of the plurality of first loaded sheets and the designated number of sheets, and on the thickness of the one sheet.

10. The sheet processing apparatus according to claim 8, wherein
the message is a message that prompts the user to change the designated number of sheets to a smaller value.

11. The sheet processing apparatus according to claim 8, wherein
the message is a message that prompts the user to change sheets used in creating the bundle of sheets to a type with a smaller thickness.

12. The sheet processing apparatus according to claim 8, wherein
the message is a message that prompts the user to perform an input indicating whether to abort the creation of the bundle of sheets.

13. The sheet processing apparatus according to claim 1, wherein
the first threshold is a predetermined value.

14. The sheet processing apparatus according to claim 1, wherein
the control unit is further configured to calculate a second threshold by reducing the first threshold by an adjustment value based on at least one of a type, a thickness, and a size of sheets designated by the job, and notify a user of a warning in a case where the thickness of the plurality of loaded sheets exceeds the second threshold.

15. The sheet processing apparatus according to claim 1, wherein
the control unit is further configured to calculate the first threshold by reducing a predetermined reference value by an adjustment value based on at least one of a type, a thickness, and a size of sheets designated by the job.

16. An image forming system, comprising:
an image forming apparatus that forms an image including an adhesive image on a sheet based on a job; and
a sheet processing apparatus to which the sheet is conveyed from the image forming apparatus,
wherein
the sheet processing apparatus includes
a conveyance unit configured to convey the sheet from the image forming apparatus to a loading board,
a bonding unit configured to execute bonding processing for bonding together a plurality of loaded sheets loaded on the loading board, with use of the adhesive image formed on the plurality of loaded sheets, and
a control unit configured to control the bonding processing executed by the bonding unit in order to create a bundle of sheets from a designated number of sheets designated by the job, and
the control unit is further configured not to execute the bonding processing with respect to the plurality of loaded sheets in a case where a thickness of the plurality of loaded sheets exceeds a first threshold.

17. The image forming system according to claim 16, wherein
the control unit is further configured to calculate the first threshold by reducing a predetermined reference value by an adjustment value, and
the adjustment value is a value based on a density of an image that is formed by the image forming apparatus with respect to the designated number of sheets composing the bundle of sheets.

18. The image forming system according to claim 16, wherein
the control unit is further configured to calculate the first threshold by reducing a predetermined reference value by an adjustment value, and
the adjustment value is a value based on whether the image forming apparatus forms an image on both sides of the designated number of sheets composing the bundle of sheets.
